(19) United States
(12) Patent Application Publication
(10) Pub. No.: US 2016/0337490 A1
(43) Pub. Date: Nov. 17, 2016

(54) Mobile Terminal

(71) Applicants: Zhengmin Banjamin Pan, LA, CA (US); Xiaoyu Zhang, Shenzhen (CN); Jiangjun Yang, Shenzhen (CN)

(72) Inventors: Zhengmin Banjamin Pan, LA, CA (US); Xiaoyu Zhang, Shenzhen (CN); Jiangjun Yang, Shenzhen (CN)

(73) Assignee: AAC Technologies Pte. Ltd., Singapore city (SG)

(21) Appl. No.: 14/930,279

(22) Filed: Nov. 2, 2015

(30) Foreign Application Priority Data
May 13, 2015 (CN) 201510242359.4

(51) Int. Cl. H04M 1/04

(52) U.S. Cl. CPC H04M 1/04

(57) ABSTRACT

The disclosure provides a mobile terminal including a screen used for displaying images; a support frame contained in the mobile terminal, extending from the mobile terminal and driving the mobile terminal to turn for adjusting an inclination angle of the screen; a gesture capture module for capturing a gesture in front of the mobile terminal; a gesture comprehensive judgment module for judging a corresponding function and outputting judgment signal according to the gesture captured by the gesture capture module; and a control module for controlling the support frame according to the judgment signal outputted by the gesture synthesis judgment module for adjusting the inclination angle of the screen.

### FIELD OF THE INVENTION

The present invention is related to electronic device field, especially to a mobile terminal can adjust the inclination angle.

### DESCRIPTION OF RELATED ART

Terminal can be divided into mobile/portable terminal and fixed terminal based on its mobility. Moreover, a portable terminal can be classified as a handheld terminal and a vehicle terminal according to whether it is portable or not.

With terminal being changed into multi-function, portable terminal is allowed to capture a static image or moving images, play music or video files, play games, listen in to broadcasting to implement for integrated multimedia player.

It is difficult for the existing mobile terminal with image display function to change the inclination angle according to the user's demand to make user to view better. The present invention provides an improved mobile terminal to solve the problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an illustration isometric view of a mobile terminal in accordance with a first exemplary embodiment of the present invention.

FIG. 2 is similar to FIG. 1, but from another aspect.

FIG. 3 is an illustration of the present invention of a mobile terminal in accordance with a second embodiment.

FIG. 4 is an illustration of the present invention of a mobile terminal in accordance with a third embodiment.

### DETAILED DESCRIPTION OF THE EXEMPLARY EMBODIMENTS

The present invention will hereinafter be described in detail with reference to exemplary embodiments. To make the technical problems to be solved, technical solutions and beneficial effects of present disclosure more apparent, the present disclosure is described in further detail together with the figures and the embodiments. It should be understood the specific embodiments described hereby is only to explain this disclosure, not intended to limit this disclosure.

The invention provides a mobile terminal, which can be a portable device such as mobile phone, tablet PC and so on. In order to describe the invention more clearly, take the cell phone as an example to state.

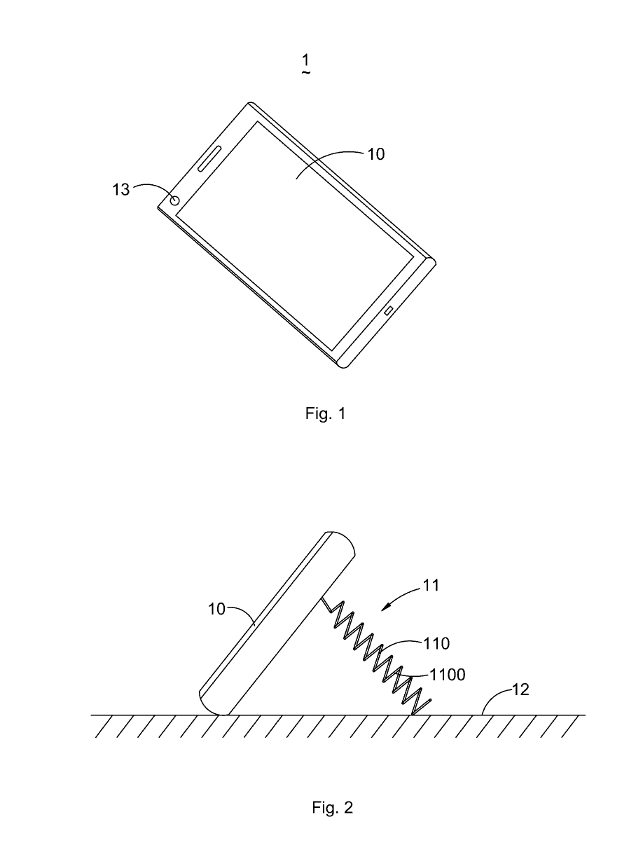

As shown in FIGS. 1-2, the mobile terminal 1 includes a screen 10 for displaying images, a support frame 11 for adjusting tilt angel of the mobile terminal, a gesture capture module (not marked), a gesture synthesis judgment module (not marked), and a control module (not marked).

The support frame 11, which is contained in the mobile terminal 1, extends from the mobile terminal 1 and drives mobile terminal 1 to turn to adjust the inclination angle of the screen 10. The support frame 11 extends from a back or a side of the mobile terminal 1, the support frame 11 includes a support rod 110, one end of the support rod 110 connected with the mobile terminal 1 hinge, and the other end contacting with and bearing on a bearing surface 12 of the mobile terminal 1.

In a first embodiment of the mobile terminal of the invention, specific as shown in FIG. 2, the support rod 110 includes a plurality of series and movably connected folding rod 1100 for driving the mobile terminal 1 to rotate by turning of the folding rod 1100, thus to adjust the tilt angel of screen 10. The support rod 110 is previously housed in the mobile terminal 1.

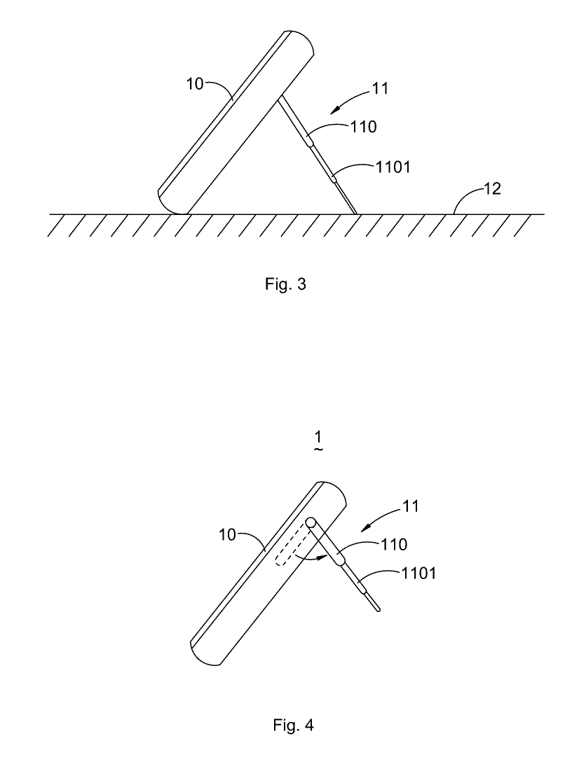

In a second embodiment of the mobile terminal of the invention, specific as shown in FIG. 3, the support rod 110 is scalable; this comprises a plurality of sheathed telescopic rod 1101, drives the mobile terminal 1 to turn by elongation or shortening, thus to adjust the tilt angel of the screen 10. Combined with the FIG. 4, as the dotted line in the figure showing, the supporting rod 110 is pre accommodated in the side of the mobile terminal 1, when the support rod 110 works, it can rotate, then to drive the mobile terminal 1 turn by shortening the elongation. Similarly, in FIG. 110, the supporting rod 3 can also be accommodated in the back of the mobile terminal 1.

The gesture capture module is used to capture a gesture ahead of the mobile terminal 1. In the invention, preferably ultrasonic wave or light to capture gestures, for example, capture gestures through an image sensor 13 of the mobile terminal 1, or setting ultrasonic transmitting/receiving device to make the gesture capture in the mobile terminal 1. When using ultrasonic, to determine the gesture by the Doppler frequency shift produced in the ultrasonic environment.

The gesture synthesis judgment module, which judges the corresponding function based on the gesture captured by the gesture capture module and outputs judgment signal. In fact, gesture library is preset in the mobile terminal 1. The specific gestures has the corresponding specific function. The gesture synthesis judgment module is comparing the gesture captured from the gesture capture module and gesture from the gesture library. Corresponding function is preset for the gestures in gesture library to judge the corresponding functions of the above captured gesture.

The existing functional modules in the gesture field are adopted for both the above gesture capture module and gesture synthesis judgment module. The idea of the invention is to use these existing function modules to achieve gesture control to adjust the inclined angle of screen 10.

The control module judges comprehensively the judgment signal output by module according to sign to control the support frame 11 to drive the mobile terminal 1 to turn to adjust the angle of inclination of the screen 10.

One support frame 11 is set on the mobile terminal 1. The mobile terminal 1 is provided by the invention. The buckling or expansion of the support frame 11 is controlled by using sign to drive the mobile terminal 1 to turn to change the angle of inclination of the mobile terminal 1.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mobile terminal including:
a screen used for displaying images;
a support frame contained in the mobile terminal, extending from the mobile terminal and driving the mobile terminal to turn for adjusting an inclination angle of the screen;
a gesture capture module for capturing a gesture in front of the mobile terminal;
a gesture comprehensive judgment module for judging a corresponding function and outputting judgment signal according to the gesture captured by the gesture capture module;
a control module for controlling the support frame according to the judgment signal outputted by the gesture synthesis judgment module for adjusting the inclination angle of the screen.

2. The mobile terminal as described in claim 1, wherein the support frame extends from a back or a side of the mobile terminal.

3. The mobile terminal as described in claim 1, wherein the support frame comprises a supporting rod having an end connected with the mobile terminal via a hinge connection and another end extending toward outside of the mobile terminal.

4. The mobile terminal as described in claim 3, wherein the support rod comprises a series of folding rods, by folding of the folding rod for drive the mobile terminal to turn, so as to regulate the inclination angle of the screen.

5. The mobile terminal as described in claim 3, wherein the support rod is expandable and contractible.
